(19) United States
(12) Patent Application Publication
(10) Pub. No.: US 2008/0254403 A1
(43) Pub. Date: Oct. 16, 2008

(54) SYSTEM FOR CNC-MACHINING FIXTURES TO SET ORTHODONTIC ARCHWIRES

(76) Inventor: Jack Keith Hilliard, Lakeland, FL (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 12/054,085

(22) Filed: Mar. 24, 2008

Related U.S. Application Data
(60) Provisional application No. 60/910,895, filed on Apr. 10, 2007.

(51) Int. Cl. A61C 7/00

(52) U.S. Cl. 433/24

(57) ABSTRACT

A method for setting an orthodontic archwire involves creating a model of a patient's dental anatomy and manipulating the virtual teeth to a desired finished condition. Virtual orthodontic brackets are installed on the virtual teeth. The virtual teeth with their virtual orthodontic brackets are returned to their original positions. A CAD model of a fixture can then be designed for setting a wire in a desired shape based on the arch slots in the virtual brackets, with activations so that the resulting archwire will store and transfer corrective energy to the patient's teeth. A CNC milling machine is employed to produce a fixture based on the CAD model of the fixture. The fixture is then assembled to hold a wire. The fixture and wire are heated to a predetermined temperature for a period of time to set the wire.

### RELATED APPLICATION

The present application is based on and claims priority to the Applicant's U.S. Provisional Patent Application 60/910,8951 entitled “System for CNC-Machining Fixtures To Form Orthodontic Archwires,” filed on Apr. 10, 2007.

### BACKGROUND OF THE INVENTION

1. Field of the Invention

The present invention relates generally to the field of orthodontics and more specifically to orthodontic archwires and methods for the custom setting of archwires to address the treatment needs of individual patients.

2. Statement of the Problem

Standard orthodontic treatment as it is currently practiced and as it has been practiced in the past has involved the attachment of brackets to the teeth of an orthodontic patient. The brackets are typically bridged by an archwire that spans the brackets. Orthodontic brackets embody a feature known as an “arch slot,” which is an occlusal-gingivally centered slot that extends mesial-distally across the face of a bracket. The arch slot serves to receive an archwire. As such, the three-sided arch slot feature opens to the labial or buccal direction, and is defined by two slot walls and a slot floor, with the slot floor oriented perpendicularly to the two parallel slot walls. Dimensional standards have emerged within the orthodontic field for sizing arch slots. Orthodontic brackets are commercially available in two standard arch slot configurations, namely 0.018 in. wide×0.025 in. deep and 0.022 in. wide×0.028 in. deep. Some orthodontic manufacturers have standardized the slot depth dimensions to 0.030 in.

U.S. Pat. No. 3,660,900 to Andrews, along with U.S. Pat. No. 4,415,330 to Daisley and U.S. Pat. No. 4,659,309 to Merkel all represent milestone improvements in orthodontic bracket design. The improvements involve the orientation of the arch slot within the bracket's structure as well as the manner in which other bracket features align with the arch slot. The 15-year span represented by the issuance of these patents represents a period of transition away from bracket designs that had remained largely unchanged from the beginning of the orthodontic specialty to modern bracket designs in use today. Today's orthodontic brackets embody the combined contributions of Andrews, Daisley and Merkel and they are commonly referred to as fully pre-programmed orthodontic brackets. A popular philosophy of orthodontic treatment based on fully pre-programmed orthodontic brackets is known as “straight wire.”

For a full understanding of the present invention, as well as the problems and limitations elegantly addressed by the Andrews, Daisley and Merkel patents, a historical review of the evolution of orthodontic bracket design follows. Prior to the innovations brought forward by Andrews, Daisley and Merkel, orthodontic brackets were by default not fully pre-programmed in any sense. In other words, accommodation of the statistically-derived values for prominence, tip and torque for the ideal repositioning of each of a patient's teeth was accomplished instead by placing what is known as first, second and third order bends in an archwire. Accommodation of such anatomical requirements for tooth positioning was not present in the bio-engineered features of pre-Andrews brackets. Standard bracket design prior to the era of innovation described above involved a system of brackets that were essentially identical and varied only in terms of mesial-distal length.

FIG. 4 in this application is based on FIG. 3 from the Andrew's patent and illustrates a prior art system of brackets 65 whose arch slots are all outset an equal distance from the facial surfaces of the crowns of the teeth 60. Stated differently, the brackets 65 of FIG. 4 are equal in terms of prominence. Another commonly-used term for the outset axis or prominence is “in-out.” Within the configuration of an individual bracket, in-out can be thought of as the distance or material thickness from the mesial-distal/occlusal-gingival center of the arch slot floor to the corresponding point perpendicularly below the slot floor on the crown of the tooth. That point on the enamel is referred to as the “slot-target point”, which is located at the junction of the crown's prominence plane and the facial extensions of the crown's mid-transverse and mid-sagittal planes.

Actually, such prior-art brackets not only lacked in-out compensation, they lacked torque and angulation compensation, as will be described below. Such brackets were known as “Standard Edgewise” brackets. Today, Standard Edgewise brackets are sometimes referred to as “zero, zero, zero” brackets because they lack any sort of biological compensation in their bio-engineering and subsequent commercial fabrication. The values for in-out exhibited by Standard Edgewise brackets are all equal around the arch, typically around 1.25 mm. The values for torque and angulation are zero. Orthodontists using a system of Standard Edgewise brackets with equal in-out values were required to install a series of in-out bends in the archwire as shown in FIG. 4. Orthodontists refer to in-out bends as first order bends. The task of incorporating a series of first order bends into an archwire was time consuming and required considerable patience and skill on the part of orthodontists of that day. FIG. 5 is another diagram of a portion of an archwire 50 in which first order bends have been installed.

As can be appreciated, in-out concerns represent just one axis of concern to orthodontists. In addition to first order bends, several other types of archwire activations were required to ideally position each of a patient's teeth. The human dentition varies naturally in height. Height, as it applies to the human dentition can be contrasted to a fence, where unlike teeth, the top edge of all of the pickets of a fence are horizontally even with each other. So, in addition to the naturally occurring, desirable variances in tooth height, an orthodontic patient typically presents with exaggerated height variances to be addressed during orthodontic treatment. Stated differently, the teeth may need vertical correction involving intruding some of the teeth lower or deeper into the gum, and other teeth may need to be extruded higher, or out of the gum. Again, unlike a fence, the incisal edges of treated teeth are not intended to be level, but nonetheless, the step of making vertical corrections to the teeth is often referred to as “leveling.”

In addition to these considerations, ideal positioning of teeth involves deviations from a true vertical axis. This can be described in this way—when viewing the facial surface of the crown of a tooth such as an upper central tooth as an orthodontist does when facing the patient, the root of that upper central tooth may need to be rotated to the left or right in a clockwise or counter-clockwise rotation. Such corrective tooth movements are referred to as correction in terms of angulation or “tip.” Taken together, both vertical intrusion/extrusion movements and “tip” movements are referred to as second order movements and the corresponding corrective wire bends placed in an archwire are known as second order bends. FIG. 6 depicts statistically-determined norms for angulation or “tip.” Statistically, maxillary centrals are best angulated 5°, maxillary laterals 9°, and cupids 11° and so on. FIG. 7 illustrates typical second order archwire compensation bends (represented by heavy black lines).

When using Standard Edgewise brackets, orthodontists prior to the 1970's were required to form yet other types of archwire bends. These were known as third order bends, which along with first and second order bends were required for full orthodontic re-positioning of the teeth. The axis and orientation of third order bends is depicted in FIG. 8. The left side of this diagram depicts the morphology of the facial surface of the crowns of centrals through second molars and the naturally-occurring inclination of the labial or buccal surfaces of those teeth. The inclination is measured at points where the curvature of the crown is bisected by a reference datum known as the Andrew's plane. The Andrew's plane is a plane oriented roughly parallel to the occlusal plane at the level where an ideally-positioned straight archwire at the end of ideal Straight wire treatment is located. The right side of the FIG. 8 shows prior-art standard Edgewise brackets and in particular, it reveals the out of register-nature of the standard Edgewise arch slots with their torque value of zero degrees. Also from the left side of FIG. 8, it can be seen that the statistically-determined normal torque value for a maxillary central tooth is 7°, a maxillary lateral tooth is ideally torqued to 3°, and a maxillary cuspid tooth is ideally torqued to −7° and so on. Such values are determined statistically from the human population of ideal occlusions. Taken as a group, the statistical values for a system of brackets has become know as a “prescription”. Various prescriptions have become available as researchers establish tooth position philosophies based in their assumptions of aesthetics, anchorage and stability. Still other prescriptions are available that are accommodative of a patient's facial type.

For standard Edgewise practitioners of the past, the installation of third-order torqueing bends was even more challenging than first or second order bends. This is due to the fact that in order for the stored torsional energy (torque) in an archwire to be transferred to a bracket, the archwire must exhibit a cross-sectional configuration that is polygonal (i.e., typically square or rectangular). The reader should understand that archwires used by orthodontists during the early phases of orthodontic treatment are generally light, round wires with diameters ranging from 0.012 to 0.016 in., or square wires measuring 0.016 in. per side. Treatment plans however normally involve a point of transition away from light, round archwires to heavier wires that are square or rectangular cross-section. Being appropriately sized and of a square or rectangular shape in cross-section, such wires are in a sense “captured” by the parallel walls and perpendicular floor of a bracket's arch slot. Use of the mechanical system consisting of an orthodontic archwire exhibiting a square or rectangular shape mechanically engaged within the parallel walls and perpendicular floor of the bracket's arch slot is termed “Edgewise mechanics.” The use of Edgewise mechanics in orthodontics is termed “Edgewise therapy.”

The first non-round Edgewise archwire used in treating a case may measure 0.016 in.×0.016 in. for example and that archwire may be used in conjunction with a bracket exhibiting an 0.018 in.-wide arch slot. The mechanical relationship between such an archwire and bracket is depicted in FIG. 9 from the distal view.

As can be appreciated, round archwires may freely rotate axially within an arch slot in an unencumbered manner. Other archwire configurations such as the square wire represented in FIG. 9 can torsionally rotate to a set radial position before mechanically binding and stopping against the arch slot walls and floor. In the case of an 0.016 in. square wire residing in a 0.018 in. arch slot for example, rotation of about 10.45 degrees in either a clockwise or 10.45 degrees in a counter-clockwise direction is permitted, thereby predicting a full stop-to-stop rotational freedom of 21.5 degrees for such an archwire/arch slot combination. The rotational freedom of the archwire in terms of torsional rotation permitted by the mechanical relationship between the archwire and its corresponding slot is called “slop”. In the above example, there was a total of 21.5 degrees of slop. So, in placing third order bends in Edgewise archwires, orthodontists had to not only anticipate the value of the corrective torque indicated, they had to also over-bend or over-activate the archwire to compensate for slop.

In addition to over-activating third-order bends to accommodate slop, it must be emphasized that over-activating the standard Edgewise archwire in all axes is part and parcel of orthodontic correction. Stated differently, simply installing first, second and third-order bends in an archwire with the goal being to simply accommodate the chaotically-positioned series of arch slots would conceptually result in a wire that would merely drop into all of the arch slots passively. Such a passive archwire would impart no corrective energy to the teeth and no tooth movement whatsoever would occur. Such activation of an archwire beyond passive is an important step in the process. The activation is after all the factor that triggers the corrective effect and efficacy of the entire armamentaria.

The great wire-bending skill required of orthodontists practicing prior to the 1970's must be appreciated. Not only did they install a combination of first, second and third-order bends in each segment of wire engaged by the arch slots, each of those bends required anticipatory over activation. It was the step of forming the over-activation that actually provided the tooth-moving forces. Doctors of that day developed great skill in the use of an array of standard wire bending instruments. These orthodontic archwire forms were available in various controlled tempers, and like an artist, developing a feel for manipulating the material was essential. Tools such as torqueing wrenches were used to establish the series of precise, sharp, twisting bends and jogs needed to unscramble their patient's teeth.

Today's fully pre-programmed Straight Wire brackets as introduced through the combined inventions of Andrews, Daisley and Merkel greatly reduce the need to bend archwires. Straight Wire brackets incorporate all of the first, second and third-order compensations within the structure of the brackets themselves. Specifically, the location and orientation of the arch slot feature of Straight Wire brackets is canted, clocked and slanted in a manner that incorporates these considerations so that an archwire can pass through the brackets in a straight, passive trajectory at the end of treatment. As such, modern orthodontists are not burdened with wire-bending duties as a central therapeutic modality and can therefore treat a larger number of patients and provide treatment at a lower cost.

In addition to the paradigm-shifting changes driven by the combined contributions of Andrews, Daisley and Merkel, another major advancement directly related to the present invention occurred in roughly the same time frame. It involved important metallurgical advancements in orthodontic wire that brought forth new alloys for archwires. Those advancements became commercially available in the early 1970's.

By the early 1970's the metallurgical advances involving conventional wire used in orthodontics had for all practical purposes exploited the range of mechanical properties available with monolithic and multi-strand stainless steel and cobalt-chromium archwires. New materials with even more advanced properties were hypothesized. In 1962, a remarkable new alloy emerged from military research. It was given the name “Nitinol.” By weight, the Nitinol alloy consists of about 55% nickel and 45% titanium. This new alloy resolved the long-sought orthodontic objective of achieving very light, continuous gentle forces. Nitinol is in fact very gentle. In terms of modulus of stiffness, in common forms, Nitinol is only about 26% as stiff as comparably-sized stainless steel wire for example.

Nitinol also exhibits an extraordinarily gentle spring rate. Once loaded, further deflection generates very little additional stress through a very wide range of deflection. Nitinol also exhibits a very unusual shape memory characteristic. Its plateau-like steady stress-strain profile was deemed theoretically ideal for generating the constant biological forces needed for tooth movement. Nitinol quickly became appreciated as being perhaps the ultimate orthodontic wire because of its remarkable combination of desirable properties. A much more refined version of the material was developed for orthodontic use as its very desirable properties provided the basis for successful commercialization. Orthodontic wires fabricated from the Nitinol alloy have come to be known in orthodontics as “Ni—Ti” wires. The use of Ni—Ti has been incorporated into the fabrication of nearly every type of orthodontic device. For example, U.S. Pat. No. 4,037,324 to Andreasen described the core methodologies for treating orthodontic cases with the Ni—Ti alloy. Ni—Ti, and its variants, which can include the addition of the elemental constituents copper and molybdenum.

The present invention is accommodative of the metallurgical characteristics and limitations of Ni—Ti. During the manufacture of Ni—Ti wire forms, such as archwires, the Nitinol raw material in its as-drawn condition is fixtured and constrained to a predetermined anatomical arch form. Once physically constrained to the desired shape, the material is heated to about 930° F. for a short period of time to set its net shape. The time-at-temperature required to set the net shape is dependent on thermal mass of the fixturing and cross-sectional area of the Ni—Ti wire, but typically for orthodontic-sized wire, it requires only a minute or a few minutes of time at temperature. It is not necessary to attain an exact temperature. A range of temperatures can be used for such shape-setting. One commercial net-shape-setting process for example utilizes the electrical resistance of the alloy. The shape-setting temperature is attained by applying the appropriate combination of voltage and amperage to the ends of the fixtured wire segment. The current through the wire is regulated to hold the wire at the desired temperature for the required dwell even though the electrical properties of Ni—Ti change as the metallurgical condition of the wire changes during the heat treatment. Once the wire cools, it is released from the fixturing and it passively retains its fixtured shape. Another shape-setting commercial process simply takes the constrained wire form(s) to temperature in an appropriate industrial furnace.

The heat treatment/net-shape-setting process normalizes the Ni—Ti material while its metallurgical grain structure remains in a metallurgical state known as complete austenite. The characteristic austenitic grain structure is maintained all the way down to a temperature termed as the alloy's “transformation temperature.” The transformation temperature threshold through which the wire passes as it cools is adjustable by varying other earlier processing parameters and by slight variances to the alloy constituents. For orthodontic applications, the transformation temperature is most commonly set above body temperature, although other desirable effects can be obtained with the transformation temperature set slightly below body temperature.

As Nitinol cools from metallurgical high shape-setting temperatures to below its transformation temperature, it undergoes a dramatic transformation in its mechanical properties. In this condition, called the martensitic phase, it is notably softer, extremely malleable and gentle. In the martensitic phase, the alloy exhibits a nearly flat profile for a portion of its stress-strain curve. It is the martensitic phase that has proven to be so appropriate as a physiological generator of orthodontic tooth-moving forces.

One of the unique properties of the phase transition between the two metallurgical states of Ni—Ti is that it is completely reversible. The material can undergo the transition between the martensitic and austenitic phases by moderate temperature cycling or by inducing and then removing mechanical stress. The mechanical properties exhibited by Ni—Ti wire in its austenitic and martensitic phases are distinctly different as are the properties exhibited by the material when it is in transition between the two states. To summarize, it can be said that the metallurgical properties of Ni—Ti are a result of a reversible solid-state phase transformation from austenite to martensite on cooling (or by deformation) and the reverse transformation from martensite to austenite on heating (or upon release of the deformation load).

A detailed discussion of the nature of the reversible phase transition properties of Ni—Ti is provided by Garrec et al., “Stiffness in Bending of a Super elastic Ni—Ti Orthodontic Wire as a Function of Cross-Sectional Dimension,” The Angle Orthodontist, vol. 74, no. 5, pp. 691-696 (2003). At large deformations, Ni—Ti alloy wires exhibit super elastic behavior. This type of behavior is also called pseudo-elasticity, because there is a complete return to the origin in a loading-unloading cycle, similar to that in a classic linear elasticity. The path of return generates a hysteresis that depends on the amount of dissipated energy during the mechanical cycling. At the beginning of the strain, the alloy is austenitic and stable. At some critical force (F_{c}), which depends on temperature, the martensitic transformation occurs. Thus, the mechanical behavior of Ni—Ti wires is largely under the dependence of martensitic transformation. The plateau is caused by the ability of martensite to accommodate the applied deflection, by selecting the most favorably oriented variants along the direction of the strain. Each variant is connected with another variant by a twinning plane (intervariant interface), which moves easily upon loading.

At this temperature and without acting stress, this martensite is unstable, and specimens recover their original shape after unloading. The reverse transformation causes an unloading plateau. The original shape recovers completely by reverse transformation accompanied by the reverse movement of the interface between austenite and martensite phases. In this case, the elastic deformation is not a stretching out of bonds but results from a phase transformation with new equilibrium positions of atoms. It is a crystallographic structural change. The growth of most favorable martensitic variants accommodates the applied stress. This phenomenon requires lower energy than the pursuit of the Hookean elasticity and prevents the plastic deformation of the austenite in this temperature and stress range.

As can be appreciated, the goal of generating ideal, but exceedingly light force levels for tooth movement can in theory be achieved by the accommodative super-elastic properties of Ni—Ti. The remaining constraint for fulfilling this goal ironically involves the lack of formability of Ni—Ti wires (i.e., the inability of Ni—Ti to permanently undergo practical degrees of plastic deformation) due to its extraordinary shape-memory characteristics. In the hands of orthodontists, super-elastic Ni—Ti wires are nearly impossible to permanently bend and only with difficulty can slight, oblique permanent bends of large radius be formed at all. Such broad bends require extreme over-bending to accomplish, and the resulting energy storage capacity within such bends is usually variable or unpredictable. The unpredictability is due to the fact that the formation of a bend results from exceeding both the martensitic “stretch” accommodation and then the yield of the martensitic structure in a conventional crystallographic grain structure shearing sense. Such actions are truly destructive to the complex crystallographic structure of Ni—Ti. As such, two identical-appearing bends symmetrically placed on the right and left sides of an archwire, for example, can elicit widely varying physiological response due to the variably destructive effects of ill-advised bends in Ni—Ti wire.

Unfortunately, orthodontists are accustomed to installing many types of formed shapes and bends in standard stainless steel wires. As described in detail above, before today's fully preformed straight-wire bracket systems were introduced basic tooth positioning was achieved by installing a combination of first, second and third order bends for each tooth in stainless steel and cobalt chromium archwires (and earlier, gold wires) to correct the position of the teeth. Above, a detailed description of why such bends must all be over-activated to achieve tooth movement has been provided. Historically speaking, wire bending is a central part of the orthodontist's vocation.

In addition to primary tooth-moving bends, other types of bends (e.g., closing loops and omega loops) can be activated using instruments to progressively create space or to close an extraction site. “T” loops, omega loops, helical loops and all sorts of hieroglyphic-forms are routinely installed in stainless steel archwires to adjust the spring rate and forces where needed around the arch and for expansion or contraction of the arch. An orthodontist can intrude all of a patient's lower anterior teeth by installing sharp and judicious bends on either side of an archwire, thus tilting the entire anterior segment of an archwire downward for example. Bending of archwires, segmental arches and wire segments is oftentimes accomplished for reasons other than for direct tooth movement or tooth re-positioning. For example, distal bends in archwires prohibit them from being pulled forward through buccal tubes thus establishing a set length and a “stop” to expansion built into an archwire. This step is known as a “cinching back” of the archwire. Cinching back is typically accomplished to unite the entire arch for anchorage in apposition to the other arch, or to pull an entire arch distally for example. A stop bend can be formed in a stainless steel archwire so that a tooth or a group of teeth can bodily translate to a desired position along the archwire, but cannot undesirably move any further. A midline “v” bend can serve to maintain a symmetrical position of an archwire preventing it from sliding laterally and out of position.

It is due to the fundamental limitation of Ni—Ti wires involving their lack of formability compared to conventional wires that has relegated Ni—Ti archwires to phases of treatment where bends are not generally helpful. In a first phase role, round Ni—Ti wires easily outperform small-diameter round monolithic and multi-strand conventional wires due to the remarkable ability to rapidly level the arches and unscramble severely mal-positioned teeth. Ni—Ti wires in a square and rectangular (Edgewise) cross section are commercially available, but the inability of such wires to accept tight forming and bending other than the mildest adaptations has significantly reduced the utility of such wires. Thus, the dilemma faced by orthodontists is that once having found the ideal wire, there has been no practical way to form it at chair-side. Its application for mid and late treatment phases, and many other specific tasks has been limited.

Solution to the Problem. In response to these problems associated with the prior art in this field, the present invention provides a system for CNC-machining case-specific fixtures to set archwires during heat treatment. This serves to combine: (1) the control and tooth-specific activations allowed by the installation of first, second and third-order bends in orthodontic archwires; while (2) avoiding the time consuming and exacting challenges of manually installing such bends; and (3) expanding the utilization of the desirable qualities of super-elastic Ni—Ti further into applications where its lack of formability has been a limiting factor. Thus, the present invention provides a means to integrate Edgewise mechanics much earlier in treatment than is possible with conventional alloys by providing bend-activated Ni—Ti wire for first phase treatment by providing means for readily forming a series of progressive archwires incorporating first, second and third-order bends and activations.

### SUMMARY OF THE INVENTION

This invention provides a system for CNC machining of customized fixtures for setting and heat treating orthodontic archwires. In particular, a CAD system is used to support a virtual model of the patient's original malocclusion. The virtual teeth are moved to their finished positions (i.e., their positions after treatment) then allowing virtual brackets and other orthodontic components to be ideally installed. The virtual teeth are then returned to their original pre-treatment positions along with the virtual brackets. The arch slot datums from the virtual brackets are activated by the CAD technician, and then used within the CAD system to design a fixture (e.g., a mandrel and retaining parts) to hold an archwire. The CAD model of the fixture is converted by CAM software into CNC programs that can be used by a CNC milling machine to fabricate the components of a physical fixture.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified block diagram of present system.

FIG. 2 is a simplified flow chart of the major steps in the present methodology.

FIG. 3 is a perspective view of a mandrel 30 holding an archwire 50.

FIG. 4 is diagram illustrating a prior art system of orthodontic brackets 65 whose arch slots are all outset an equal distance from the facial surfaces of the crowns of the teeth 60.

FIG. 5 is a diagram of a portion of an archwire 50 in which first order bends have been installed.

FIG. 6 is a diagram depicting statistically-determined norms for angulation of teeth.

FIG. 7 is a diagram illustrating typical second order archwire compensation bends (represented by heavy black lines).

FIG. 8 is a diagram depicting an example of the axis and orientation of third order bends.

FIG. 9 is an end view of a conventional bracket 65 with a square archwire 50.

FIG. 10 is a top perspective view of an example of a set of virtual arch slots 40 created in step 23 of FIG. 2.

FIG. 11 is a top perspective view corresponding to FIG. 10 after a virtual archwire 50 has been formed into the arch slots 40.

FIG. 12 is a top perspective view of the virtual archwire 50 corresponding to FIG. 11 showing the archwire datums.

FIG. 13 is a CAD image illustrating the process of constructing virtual webs 45 based on each of the archwire datums.

FIG. 14 is a perspective view of an example of a mandrel 30.

FIG. 15 is a perspective view of the mandrel 30 being assembled with a distal brace 38 and bilateral archwire holders 34 to form a fixture 18.

FIG. 16 is an exploded detail perspective view of a bolt-down retainer plate 36 with a portion of a mandrel 30.

FIG. 17 is another perspective view of a fixture 18 in which the distal brace 38 includes clearance holes allowing the ends of the archwire 50 to extend out of the assembly.

FIG. 18 is a cut-away view showing the manner in which the archwire 50 is held on three sides by the mandrel 30 and on the fourth side by the wire holder 34 in the embodiment depicted in FIGS. 15 and 17.

FIG. 19 is a cut-away view of another embodiment in which the archwire 50 is held on two sides by the mandrel 30 and on two sides by the wire holder 39.

FIG. 20 is a cut-away view of another embodiment in which the archwire 50 is held between a V-shaped slot 32 in the mandrel 30 and a wedge-shaped wire holder 39.

### DETAILED DESCRIPTION OF THE INVENTION

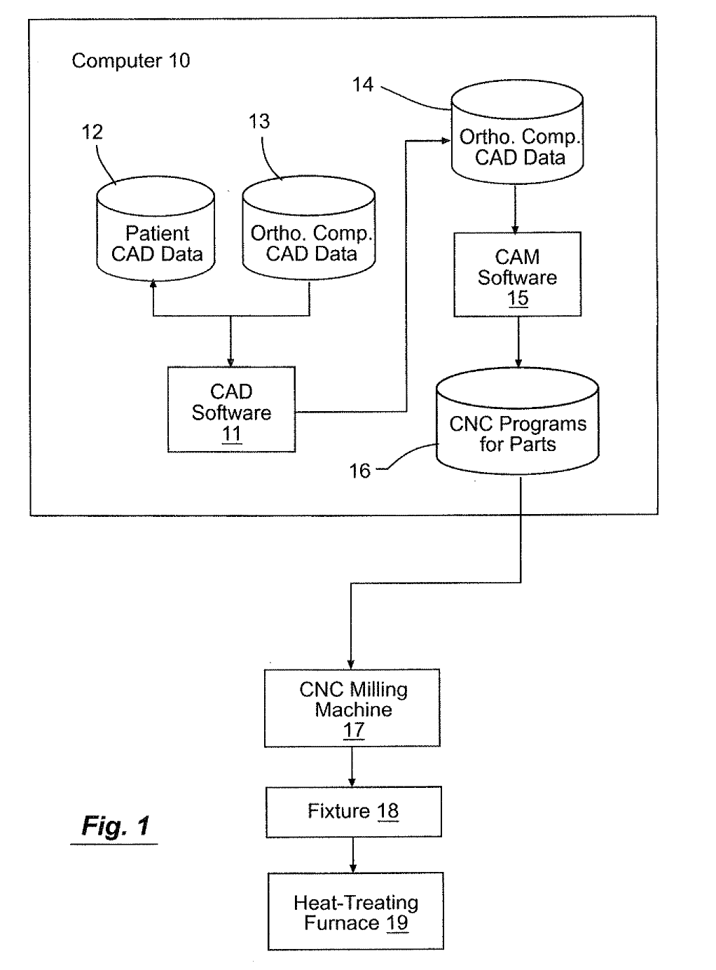

System Diagram. Turning to FIG. 1, a simplified block diagram of the present system is provided. The major components in FIG. 1 include a computer 10 equipped with a processor, memory, a number of data storage devices (e.g., a disk), keyboard, mouse, and display. The computer 10 can also include optional hardware, such as a printer, other types of CAD input devices, and an optical (e.g., laser) scanner or other means suitable for digitizing orthodontic models of patient's dental anatomy. The computer 10 is also equipped with suitable software for computer-aided design CAD 11 (e.g., SolidWorks, Pro-E) to enable a user to create and manipulate virtual CAD models of physical objects. This combination of computer hardware and software can be collectively termed a “CAD system.” Alternatively, the CAD system can be implemented by a plurality of computers communicating over a local area network (LAN), wide area network (WAN) or the internet.

As shown in FIG. 1, the CAD system contains CAD files containing a virtual model of the patient's original malocclusion (i.e., the patient CAD data files 12), as well as CAD files 13 of each bracket, buccal tube and other orthodontic components intended for use in treatment of the patient. These CAD files are used by the CAD system in the present invention to design a heat-treating fixture 18 for setting a wire, as will be described in detail below. The resulting virtual models of the heat-treating fixture 18 and related parts are stored in a number of part CAD data files 14 shown in FIG. 1.

The computer 10 also includes computer-aided machining (CAM) software 15 for converting the part CAD data files 14 into a series of CNC programs 16 for machining the fixture 18 and related parts. Alternatively, the CAM software could be operated on a separate computer. These CNC programs 16 are then be used to operate a CNC (computer numerical control) milling machine 17 to actually produce these components. Finally, the fixture 18 and its related parts are assembled, loaded with an orthodontic wire, and the entire assembly is placed in a heat-treating furnace 19 for a period of time to set the wire in the desired shape.

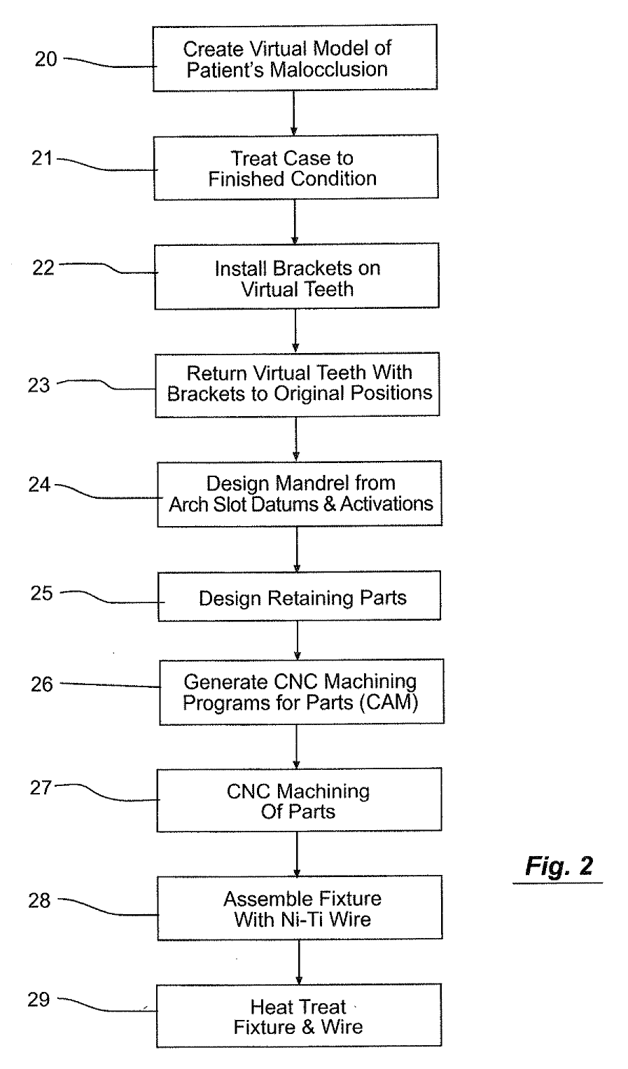

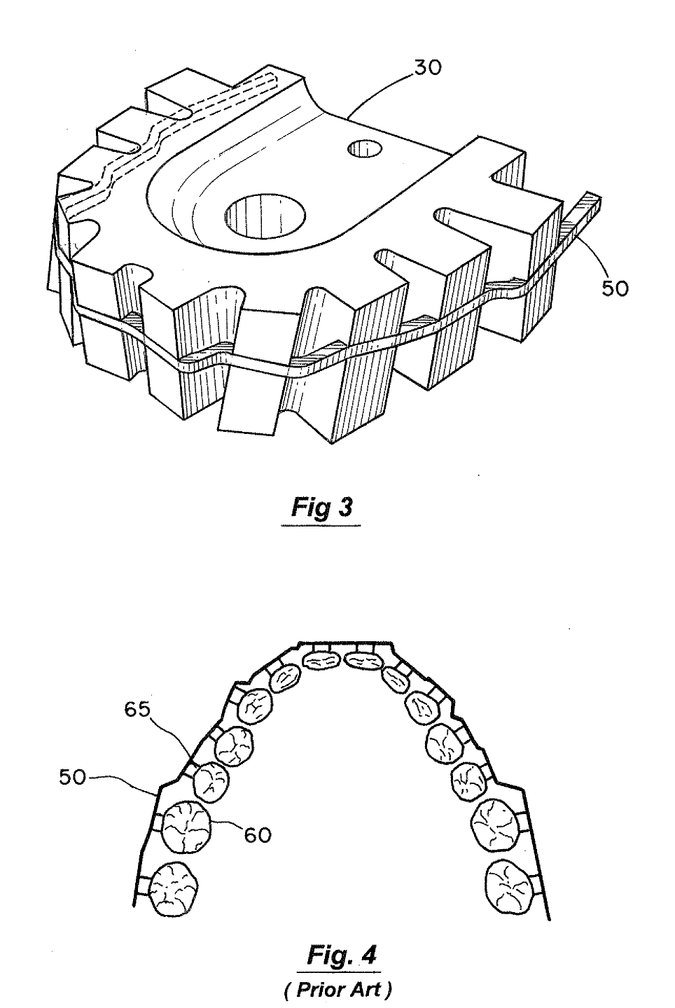

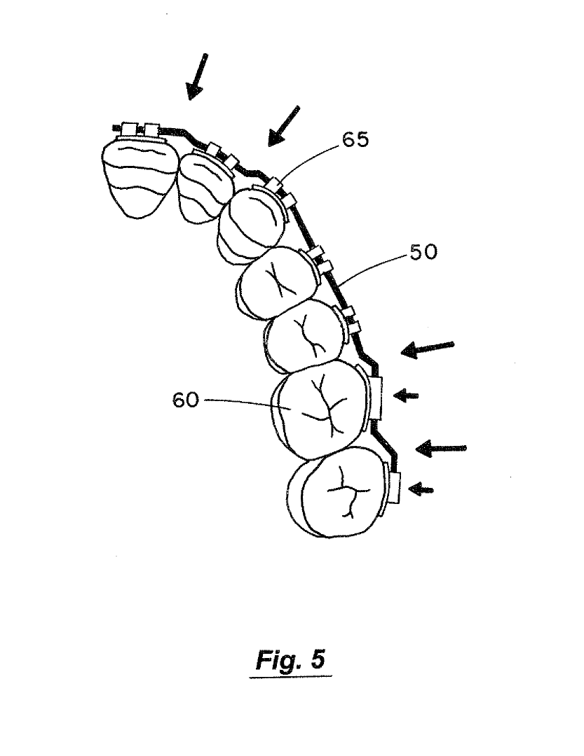

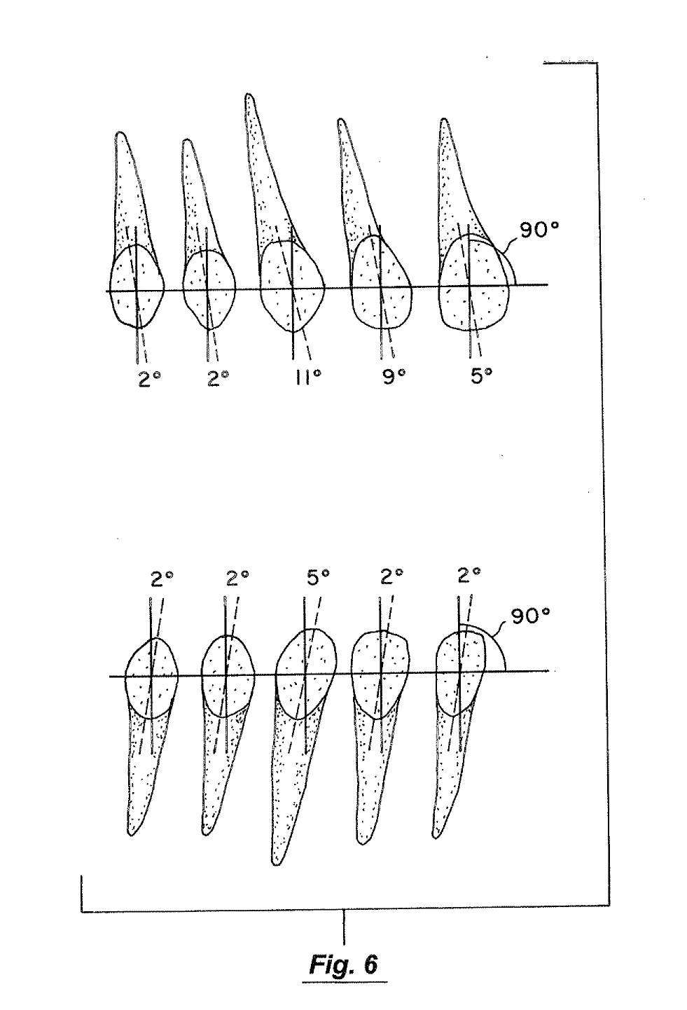

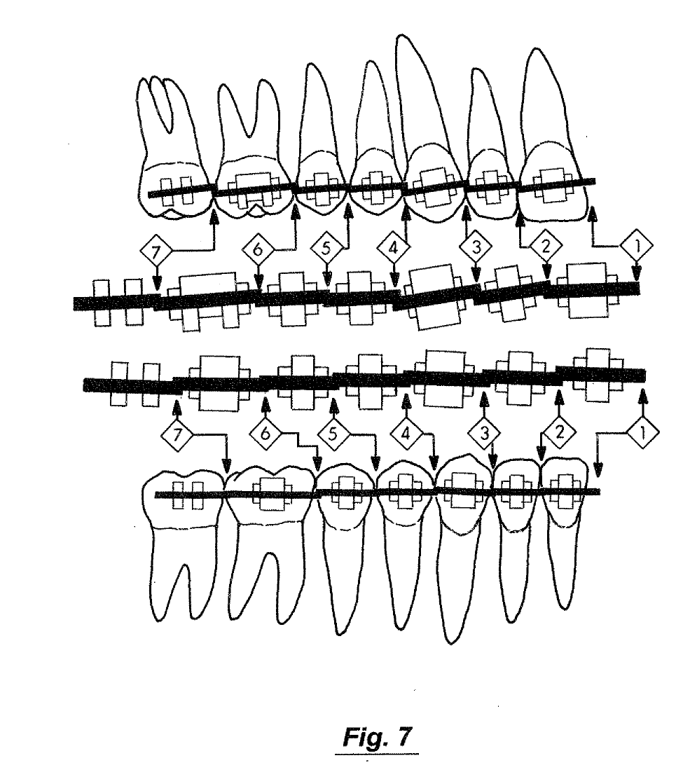

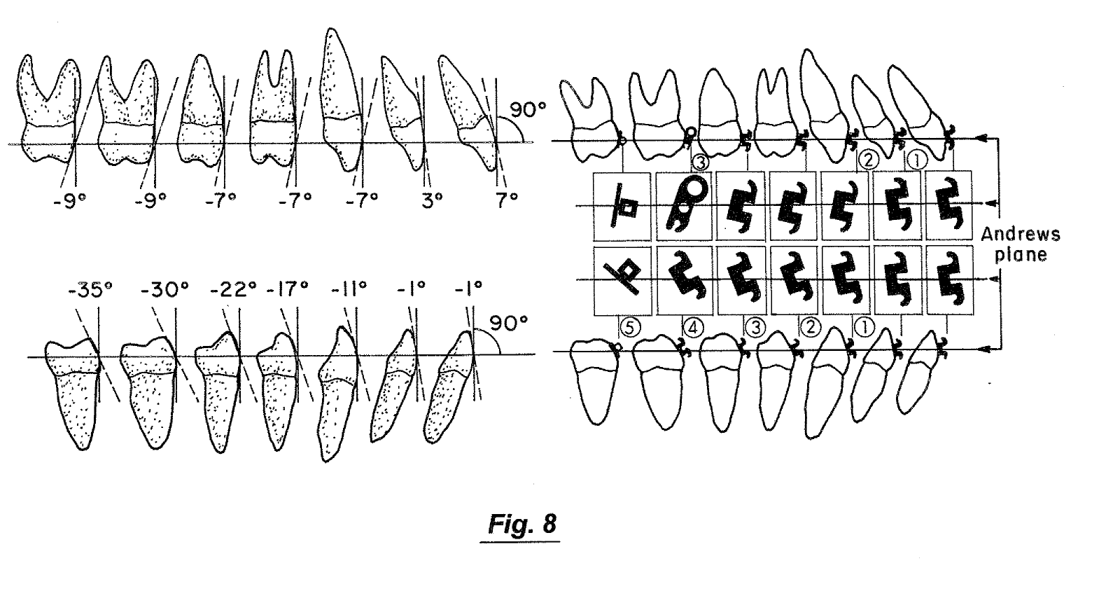

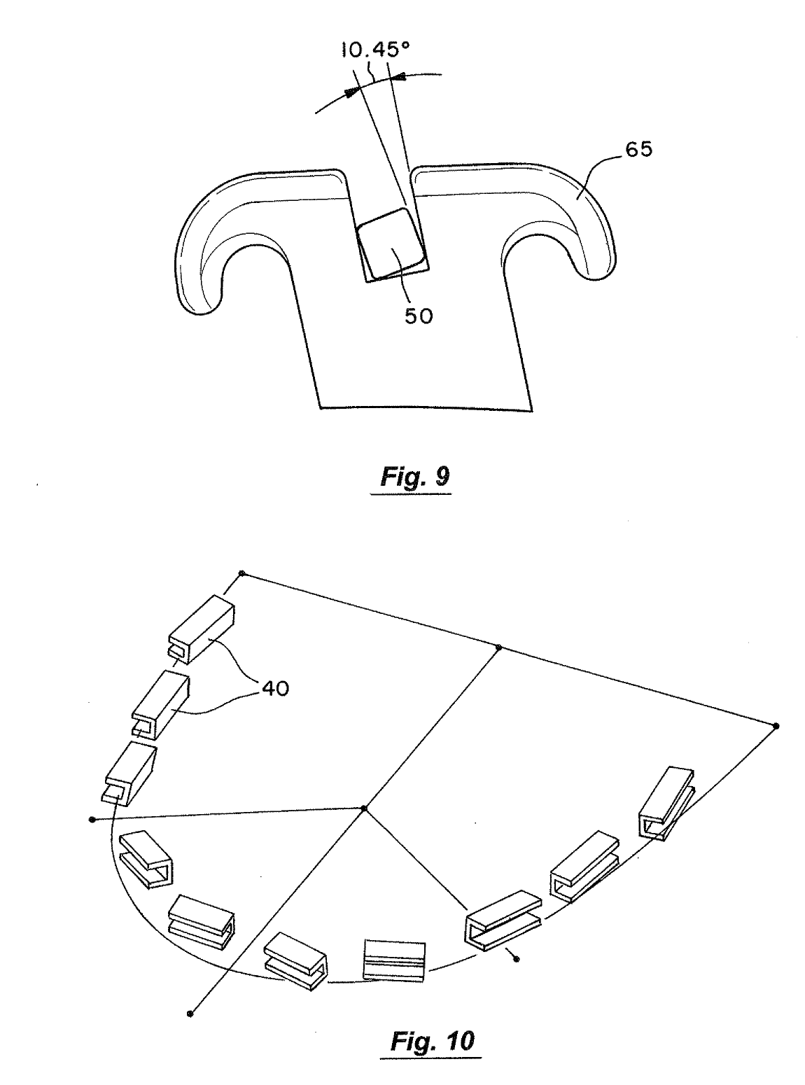

Method of Operation. The steps in the present methodology are illustrated in more detail in the flowchart depicted in FIG. 2. An initial step 20 involves creation of a virtual CAD model of the patient's pre-treatment malocclusion. This model is stored in the patient CAD data files 12 shown in FIG. 1. For example, this step can be accomplished by three-dimensional digital scanning of conventional stone models of the patient's dental anatomy. Alternatively, the patient's dental anatomy can be directly scanned. Other types of conventional scanning could also be used to create the CAD model.

Step 21 involves virtually treating the dentition to an ideal or finished occlusion representative of the orthodontic result at the end of conventional, successful treatment using known orthodontic techniques. With the virtual teeth in their finished ideal positions, the CAD technician installs brackets, buccal tubes and other appropriate orthodontic components (based on the preexisting orthodontic component data files 13 in FIG. 1) on all teeth in the conventional manner for orthodontic treatment (step 22).

In particular, step 22 in FIG. 2 involves installation of a virtual bracket system on the ideally-positioned virtual teeth so that the brackets are accurately sited on the teeth in the normal manner and according to standard criteria, with the arch slots of each of the brackets in coplanar registration with each other and in coplanar registration with the occlusal and gingival surfaces of an unbent and passive Edgewise archwire. This virtual bracket system is typically identical to the actual bracket system planned for use in treating the patient at least in terms of orientation and position of the bracket's arch slots relative to the tooth-contacting structures of the brackets.

In one embodiment of the present invention, a series of local coordinate systems are then created with each coordinate system being oriented according to a single tooth and restricted to that individual tooth. Each tooth's corresponding virtual bracket can them be locked-in within the local coordinate system constructed for that virtual tooth, allowing each virtual bracket to move in concert with its virtual tooth as if joined as one. It should be understood that, anatomically speaking, dentists and dental specialists have long referred to the natural coordinate system inherent in the morphology of teeth. For example, anterior teeth have a central axis that extends from the apical tip to the mid-mesio-distal width of the incisal edge. A similar axis is known as the central axis of the clinical crown. Molars have a mesio-distal width defining an axis, as well as a bucco-lingual axis and a central axis located in the central facia. These local coordinate systems inherent to each tooth are registered to these natural anatomical axes of the teeth and therefore, each such local coordinate system assigned to each tooth is unique. For the virtual moving and positioning of the teeth into ideal positions, it is the central axis of the tooth that is used to orient the tooth in terms of second order tip. Another line, tangent to the crown's bracket bonding point is used to establish third order torque. It is the incisal edge that is then referenced for intrusion/extrusion considerations of leveling and rotation about the central axis for the considerations of rotation.

One reason that having the teeth positioned in ideal occlusion provides such an opportunity for excellence in placing the brackets on the teeth is this: Modern, fully pre-programmed bracket systems contain within their structure accommodations for the natural first, second and third-order orientations of the teeth. In other words, the bonding surface of each bracket, which is the surface that closely conforms to the anatomy of the crown, anticipates the angle, torque and compound radii-contour of the crown. Such engineering and biological sophistication generally works well, provided that: (1) The crown is oriented ideally in all axes according to the same prescription values that the bracket is manufactured to. In other words, the positioning values used by a CAD technician to position the teeth into a virtual ideal occlusion match the prescription of the intended bracket system; (2) The bracket is positioned directly over its intended bonding site; and (3) The slot walls of all the brackets are coplanar. When these conditions are met, each bonding surface of each bracket will fall very close to forming an intimate cooperative relationship with the enamel surface of its corresponding crown. Commercial bracket systems are bioengineered based on statistical tooth norms of a population. Each bracket will not exactly match the tooth orientation and tooth contour of a single patient of course, but the bonding surface will nonetheless fall close.

It is a simple step for a CAD technician to align all of the occlusal arch slot walls of a system of brackets for example to be coincident/coplanar, and for all of the center points of all of the arch slot floors to be tangent to a predetermined morphologic arch form as seen in the top view. After all, in theory, at the end of straight wire orthodontic treatment, it is the archwire finally returning to its flat, straight, non-distorted shape that brings all of the teeth into finished occlusion. So, positioning the brackets on the teeth with the teeth virtually corrected according to the bracket system's prescription values provides many advantages, and in fact exploits the sophisticated bioengineering of the brackets to the fullest.

In step 23 in FIG. 2, all of the virtually-treated teeth are returned back to their original pre-treatment mal-occluded positions. This involves moving each tooth back to its untreated position with the important distinction that each tooth now carries with it its ideally-positioned virtual bracket. Returning the teeth to their original pre-treatment positions with the brackets in tow can be accomplished by locking together the natural anatomical coordinate system of each tooth as described, to the coordinate system of each corresponding bracket's prescription-defined coordinate system. The technician then removes (i.e., blanks) the teeth and molars, as well as the bulk of the brackets and buccal tubes for the CAD view, thereby leaving only the arch slot datums positioned in 3-D space according to the steps above. In other words, this step enables the technician to virtually focus only on the series of chaotically-positioned arch slot portions of each of the brackets as they have come to be oriented in the virtual CAD space after the steps above are accomplished. The teeth and the body and wings of the brackets can be thought of as being visually blanked from the virtual space leaving only the parallel arch slot wall surfaces and perpendicular floor surface of the arch slot 40 visible, as illustrated in FIG. 10.

Considering the CAD technician viewing his computer monitor at this point, it would be an easy step for the ten datums (centrals, laterals, cuspids, first and second bicuspids, times two for left and right) and even the eight buccal tube slots to be converted into a virtual archwire. To accomplish that, the CAD technician would use a sophisticated surfacing technique known as a “lofting”. By lofting, the CAD technician would join the distal of one arch slot datum to the mesial of the next and so on around the arch. Each lofted segment would represent the lowest energy twisting and bending of an inter-bracket segment to comply with the orientation of its parent datums. However, such a hypothesized archwire would be of limited treatment value in that it would be passive and incapable of transferring corrective energy to the teeth.

Therefore, the CAD technician must make modifications to selected virtual arch slots in the CAD environment in step 24 so that the resulting archwire will store and transfer corrective energy to the teeth. This process can be referred to as “activation” of the virtual arch slots. Each of the individual virtual arch slots for the relevant upper or lower arch is evaluated in terms of its first, second and third order orientation relative to oral datums, and evaluated in terms of the cross-sectional dimensions of the archwire relative to arch slot dimensions. Activation of the virtual arch slots may first compensate for slop in the third order axis (torque). Compensation for slop has been described earlier. Once slop has been compensated for, third-order activation may be functionally increased or decreased beyond the passive determination to urge the corresponding tooth toward a more desirable orientation in terms of torque. Next, the virtual arch slot may be bodily moved slightly lingually, labially or buccal to further bias the archwire to move the corresponding tooth in a first order axis toward a more desirable in-out orientation. In addition to these alterations to the arch slot's otherwise passive orientation, the virtual arch slot may be rotated in a second order sense (i.e., tip). All of these activations combine in a resulting multiple net vector sense. The effect is to position the virtual arch slot so that in order to install the flat, unbent archwire into that slot, the archwire must be bent or twisted in various ways by the orthodontist before it will be oriented appropriately to enter the arch slot. Such local bending and twisting manipulations store energy in the archwire. That stored energy is slowly dissipated as the roots of the teeth respond physiologically over time in reaction to the net vector of the gentle corrective forces generated by the deflected archwire.

Very seldom will any one activation of the position of a virtual arch slot result in the complete desirable repositioning of a mal-positioned tooth to its final, finished position. If, for example, too great of an activation is attempted, patient pain and discomfort can occur due to the archwire conveying injuriously high forces. Too-high forces can also injure the bone surrounding the root of a tooth as well as injure the tip of the root itself. In order to avoid these problems, repositioning an arch slot in any particular axis may be accomplished over several iterations, involving several progressively activated archwires. The methods taught in the present invention lend themselves to a progressive program where multiple, small, degrees of activation may be incorporated into a series of archwires. Such a series can be fabricated at one time according to the present invention and the progressive series of archwires can be available ahead of their scheduled use. In such a program, each archwire would be worn by the patient for a pre-determined period of time, after which the second archwire of the series would be worn and so on.

Considering the overall objectives of treatment, and the original diagnosis and treatment plan established for the patient by the orthodontist, the present invention can serve those objectives in several ways. For example, the present invention can serve to provide a single archwire that may be used at the end of treatment. Such an archwire would be subtly activated to counteract small positional errors that are unavoidable as the orthodontist directly bonds the brackets to the teeth at the beginning of conventional treatment. Bonding brackets directly to the teeth is an extremely challenging step. It is not until the finishing archwires used at the end of treatment are energetically spent that such errors in bracket positioning can be detected. Typically, once detected, orthodontists attempt to install subtle first, second and third-order bends in their finishing wires at the end of treatment to counter their original bonding errors and to obtain an artistic and aesthetically corrected finished result. Such efforts are often associated with “chasing the occlusion” and all too often involve the case running months longer than originally planned. An archwire provided according to the present invention can achieve near-perfect results in short order.

Alternatively, the present invention can serve to provide a series of archwires with each archwire being slightly more progressively biased in the direction of desired tooth movement. In establishing the parameters of such a progressive series, various standards for maximum tooth movement per archwire may be used. One such strategy may be to target the most mal-occluded tooth or teeth in an arch. Considering only those most out-of-position teeth, a determination can be made for the total number of millimeters of bodily movement needed, as well as the total number of degrees of torque correction and uprighting, along with considerations of the degrees of corrective rotation needed. Some teeth may further involve the considerations of extrusion or intrusion that is needed. Then, based on skeletal age, certain holistic considerations and known adolescent growth factors, an optimal increment for those movements can be determined. A rapidly-growing fourteen year old patient can certainly tolerate a more highly activated sequence of archwires than an adult who no longer has growth potential.

In determining for example whether or not a patient may do best with a series of only two or three archwires, or a series of eight or ten for example, certain assumptions can be used. A maximum of 3 degrees and 0.5 millimeter of correction may be incorporated into any one of a series of archwires for the young patient referenced above, whereas 0.3 millimeter and 2 degrees of correction per archwire may be used as the constant delta in a series for an older patient. Essentially then, it is the total amount of correction required by the most out-of-position teeth, divided by the physiologically-tolerable increment that determines the optimal number of progressive archwires that will be needed. These determinations can be arrived at through joint consideration by the CAD technician and the treating orthodontist.

The present invention can also serve to provide a series of progressive archwires as described above, with that series intended to accomplish a particular phase of treatment or a series intended for a patient's total treatment from beginning to end. In fabricating a series of archwires suitable for accomplishing only a specific phase of treatment, the first example provided above may apply. Instead of a single wire, multiple archwires may be required to finish a case if original direct bonding errors were excessive. Orthodontists may opt to employ traditional Straight wire techniques to gain most of the treatment objectives, but switch over early to archwires provided through the present invention. Such a practice, involving multiple archwires could insure an ideal result within a more accurate-to-plan timeframe. In using the present invention as a total treatment modality, the virtual pre-treatment and virtual finished treatment CAD models would provide the basis for processing an entire series of archwires for a case.

Regardless of whether a single archwire or a series of archwires is to be processed according to the present invention, the CAD technician should begin by anticipatorially activating selected arch slot datum segments away from the passive orientation achieved by step 23. This step represents only the passive orientations of the arch slots before treatment starts. The CAD technician should activate the arch slot datum segments systematically, using the first, second and third-order logic, combined with the incremental delta considerations described above. If for example, using an upper central tooth, the arch slot datum is found to exhibit a flared torque value of 18 degrees, and the ideal target is 11 degrees, and other physiological response factors have determined that there are to be five archwires in the series, the archwire segment corresponding to the upper central can be activated by the subtraction of 1.4 degrees (negative torque) for each of the five archwires. The question of which way the activation should go is answered by the premise that the activations always go from the malocclusion orientation toward the ideal occlusion orientation. Specifically, positive and negative torque are terms used to define torque direction. Such torque direction terms reference the apical tip of the tooth root. A positive torque brings the apical tip of the root inward, closer to the heart. A negative torque sees the tip moved outward, away from the heart. Conversely, in terms of the crown, a positive torque serves to tip the crown outward in a more flared position and a negative torque may be used to correct an overly flared condition. Similar considerations apply to those changes to the orientation to the datums accommodative or circular movements involving rotation and angulation.

The discussion above covers many of the questions faced by the CAD technician as he/she begins to create usefully-activated archwires according to the present invention. There are other considerations that apply however, which also must be incorporated into the decisions made by the CAD technician. For example, we must not forget that Newtonian principles involving spring rates and stress/strain of metals must be taken into consideration along with the fact that a portion of the mechanical system being considered is living structure. For the living structures (e.g., the periodontal membrane and the supporting alveolar bone), it can be said that form drives function and function drives form. In other words, there is a threshold of forces acting on the living tissues below which no response will be elicited. Orthodontic forces, in order to be effective must be sufficiently high to trigger a response in the living tissue.

From strictly mechanical considerations, the archwires most suitable for forming according to the present inventive methods generally exhibit a low spring rate. This means that in order for them to surpass the minimum threshold for triggering a physiological response, they must be over-activated to some pre-determined degree.

In combining the over-activation needed by the low rate wires, and the over-activation according to the biological factors, it can be seen that the CAD technician must establish ranges for activation beyond the strictly geometrically-determined values described earlier. Such over-activation values can be determined based on the modulus of stiffness of the archwire material, as well as considerations effecting the physiological response such as age, health and the patient's remaining growth potential and combined with the strictly geometric increments to arrive at a practical set of guidelines for the CAD technician to use according to the steps of the present invention.

As can be appreciated, the orientation of the arch slots at the conclusion of the activation process in step 24 can be seen as a series of chaotic and mal-aligned arch slots based on, but proactively positioned from the patient's randomly-positioned teeth. Such a system of arch slots positioned within virtual 3-D space may appear as depicted in FIG. 10.

Only the arch slot portions 40 of the system of brackets are shown in FIG. 10. The four lower anterior arch slots shown are representative of lower anterior-type brackets from which they are derived, and as such exhibit a mesial-distal slot length of about 2.25 mm. The posterior arch slots in FIG. 10 are representative of lower cuspid and bicuspid-type brackets from which they are derived and as such, they exhibit a common slot length of about 3 mm. All of the arch slots 40 depicted represent the 0.022×0.030 in. arch slot standard. However, other arch slot dimensions could be easily accommodated.

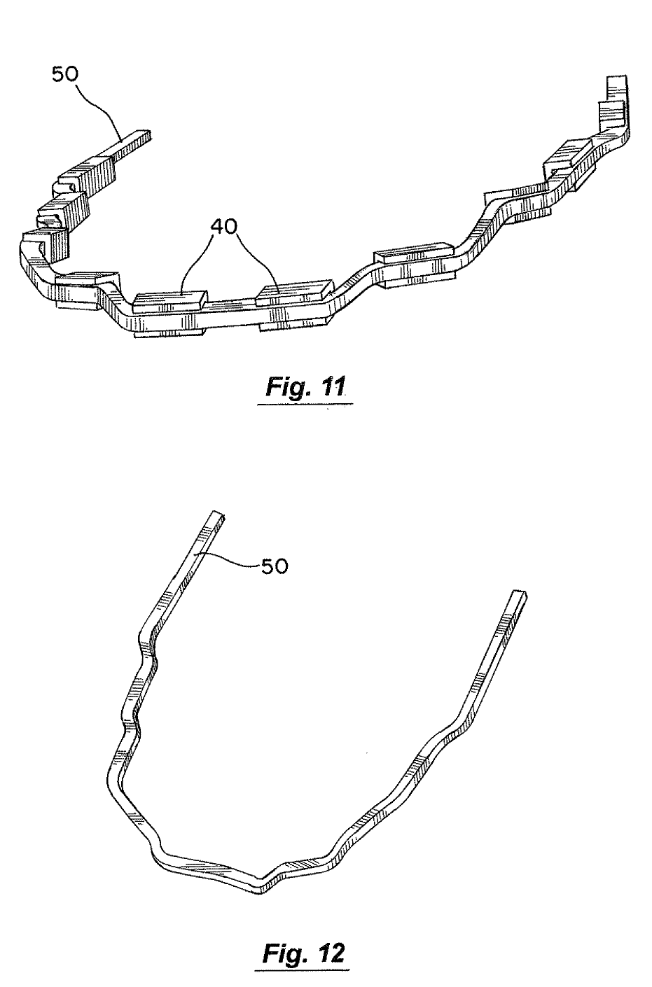

FIG. 11 depicts a virtual Ni—Ti archwire 50 that has been adapted to the fall passively within all of the arch slots 40 according to the present invention. The virtual archwire 50 is captured within the system of arch slots 40 representing teeth of the lower arch of a patient. The following points should be made regarding the virtual archwire 50 shown in this figure. First, the straight portions of the archwire 50 residing within the arch slots 40 are straight, locally passive and geometrically true to the walls and floor of the slot. The size and extent of those locally-passive archwire portions correspond to the dimensions of the arch slot portions of the actual system of brackets intended for use in treating the patient. Being straight, locally-passive and true, those arch slot-dwelling portions of the archwire 50 can be considered as being “datums.” The datums are considered as having a length, width and depth matching the dimensions of the arch slot 40 in which they reside during treatment. Second, it is only the curving and twisting adaptive segments of wire falling in between the datums that are activated to store corrective, tooth-moving energy. Third, the archwire 50 as shown is engaged by arch slots 40 extending back through the second bicuspids but preferably an archwire formed according to the present invention would extend further to the posterior teeth to engage similar arch slots attached to the molar teeth. The molar-borne arch slots are integral to a different category of brackets called buccal tubes. Finally, it must be understood that the archwire 50 shown in FIG. 11 is intended to exist in a virtual sense only, and is created within a virtual CAD space driven exclusively by the orientation of the arch slot portions of the brackets as oriented in three-dimensional space according to the preceding steps.

A mandrel 30 is a central device of the heat-treating and shape-setting fixture 18 to be created by the present invention. For the purposes of this patent application, the word “mandrel” should be broadly interpreted as covering any type of curved form, template or jig suitable for setting a wire into a desired shape. In the embodiment shown in the drawings, the mandrel 30 is generally arch-shaped to correspond to the shape and dimensions of a patient's dental arch. It should also noted that the mandrel could have either a concave or convex arch shape.

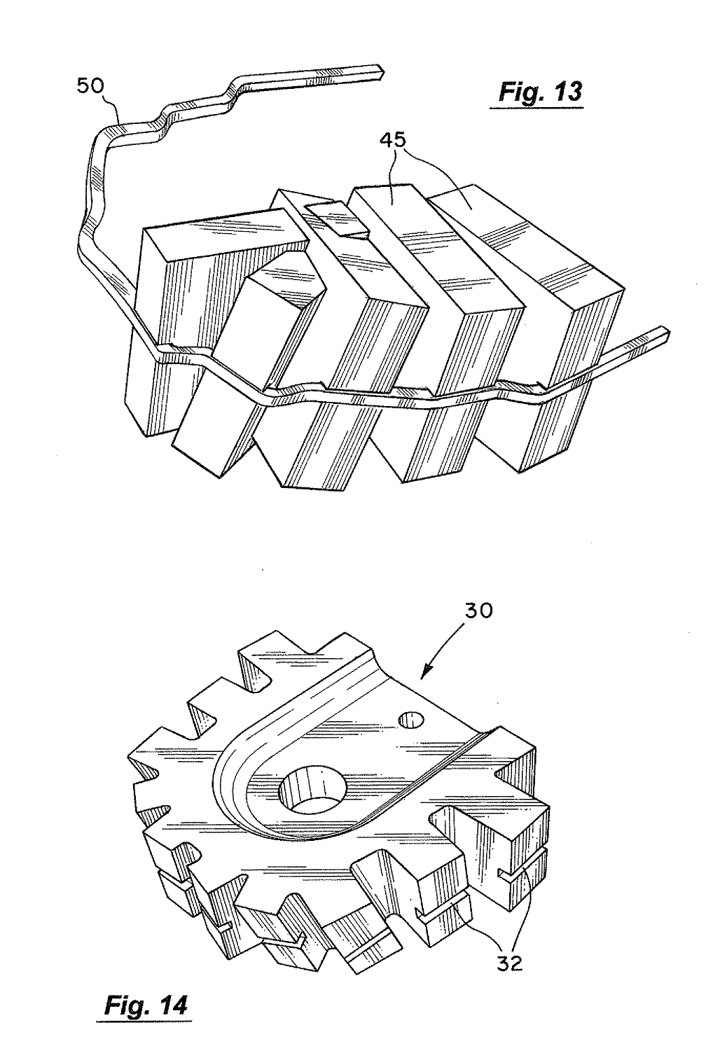

The mandrel 30 is initially designed in the virtual CAD space in step 24 in FIG. 2. In the example depicted in the drawings, the configuration of the mandrel can be constructed virtually based on the planar surface portions (datums) of the virtual archwire 50 shown in FIG. 12. Again, this virtual archwire includes segments representing the datums that will reside in the arch slots of the orthodontic brackets 40 in FIG. 11. Being geometric datums, they are suitable for serving as a beginning foundation for the CAD-creation of the Ni—Ti heat-treating and shape-setting furnace mandrel to be described below. The first step of such a process is to construct virtual webs 45 based on each of the archwire datums. Of the five webs 45 shown in FIG. 13 representing the first steps in the virtual creation of a Ni—Ti heat-treating and shape-setting furnace mandrel, each web is oriented in a Cartesian or orthogonal relationship with its respective datum. The CAD-related steps of the present invention see the datum-based webs 45 being involved in a CAD construction process where the multiple webs 45 are trued-up, joined and contoured resulting in a single virtual heat-treating and shape-setting furnace mandrel 30 as shown for example in FIG. 14 and described below.

For example, using each arch slot datum positioned according to the steps above as a basis, The CAD system can be used to create virtual extrusions from each arch slot datum in occlusal, gingival and lingual directions so that these extrusions (or webs) 45 violate each other by overlapping to some extent. An example of this process is illustrated in FIG. 13. The CAD system is then used to join all of the extrusions into one virtual CAD part (i.e., the mandrel 30). The CAD system can then trim the common planar top and bottom surfaces of the mandrel 30, and cut and fillet in between the original web structures 45 for clearance, as required.

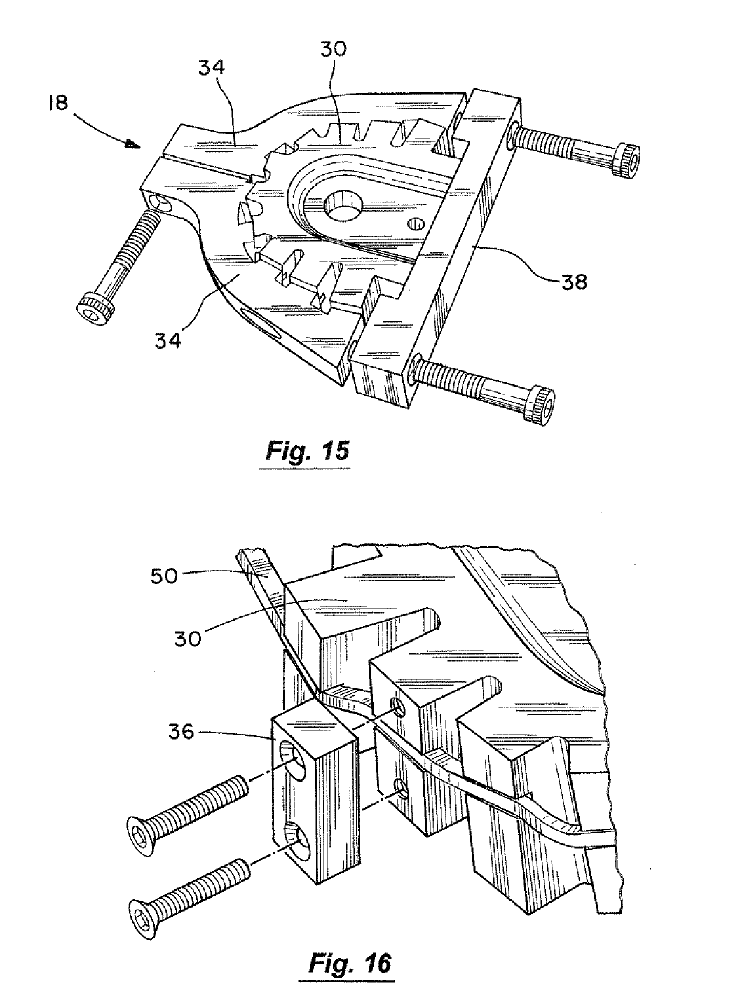

In step 25 in FIG. 2, the CAD system can be used to create a number of archwire-retaining parts (e.g., archwire holders 34 and distal brace 38 in FIG. 15) as separate CAD parts. These retaining parts 34, 38 are designed to be assembled with the mandrel 30 to create a fixture 18 capable of holding an archwire 50 during heat treating, as will be described below. For example, if the mandrel 30 has a convex arch shape, the retaining parts can be designed with a complementary concave arch shape to removably attach to the exposed outer surface of the mandrel 30 to secure the wire in the slots of the mandrel, as shown in the drawings. Alternatively, if the mandrel 30 has a concave arch shape, the retaining parts can be designed to removably attach within the concavity of the mandrel 30. The retaining parts could also be implemented as a series of small clips, stops or plates 36, as illustrated in FIG. 16, that removably attach over the slots in the mandrel 30 to hold the wire 50 in place during heat treatment.

After virtual models of the retaining parts 34, 38 have been created in the CAD system, the CAD technician can create a virtual assembly of the mandrel 30, distal brace 38 and archwire holders 34. Once the components have been virtually mated, the CAD technician installs clearance and tapped holes in the virtual assembly for subsequent installation of fasteners.

In step 26 in FIG. 2, CAM software 15 is used to generate a set of CNC programs 16 based on the CAD solid models of the mandrel 30 and its archwire-retaining parts 34, 38 to enable a CNC milling machine 17 to fabricate these components. In particular, the CNC programs 16 generated by the CAM software 15 define tool paths and cutter sequences as well as other instructions for CNC milling of the mandrel 30 and other related parts 34, 38.

In step 27 in FIG. 2, the mandrel 30 as shown in FIG. 14 is robotically machined (along with its archwire-retaining parts 34, 38) based on the CNC programs 16. For example, this can be done using a CNC milling machine or any other suitable CNC machining technology. CNC-machining of a volume-produced cast aluminum alloy blank is a practical means for reducing machining time. Aluminum alloys are machined rapidly and accurately. Aluminum melts at temperatures well above the anticipated heat-treating temperatures. For these reasons, aluminum is a preferred material.

After CNC machining is complete, the fixture 18 is assembled and a Ni—Ti wire segment is loaded into the mandrel 30 (step 28 in FIG. 2). In particular, a distal brace 38 and bilateral archwire holders 34 are shown with the mandrel 30 in FIG. 15. A segment of Ni—Ti wire 50, exhibiting a super-elastic martensitic phase condition, is laced into the arch slots 32 of the mandrel 30. In cases where dramatically divergent slot orientations exist from web to web, a ligature may serve to temporarily retain the wire at least partially within the mandrel's arch slots 32. The ligature temporarily engages the central hole in the mandrel 30 and engages the archwire 50 in between slot engagements for assembling the fixture. It should be understood that the cross-sectional dimensions (rectangular as shown) of the wire segment accurately matches the dimensions of the arch slots 32 of the mandrel 30. Thus the arch slots 32 of the mandrel 30 capture and immobilize the datum segments of the Ni—Ti wire 50.

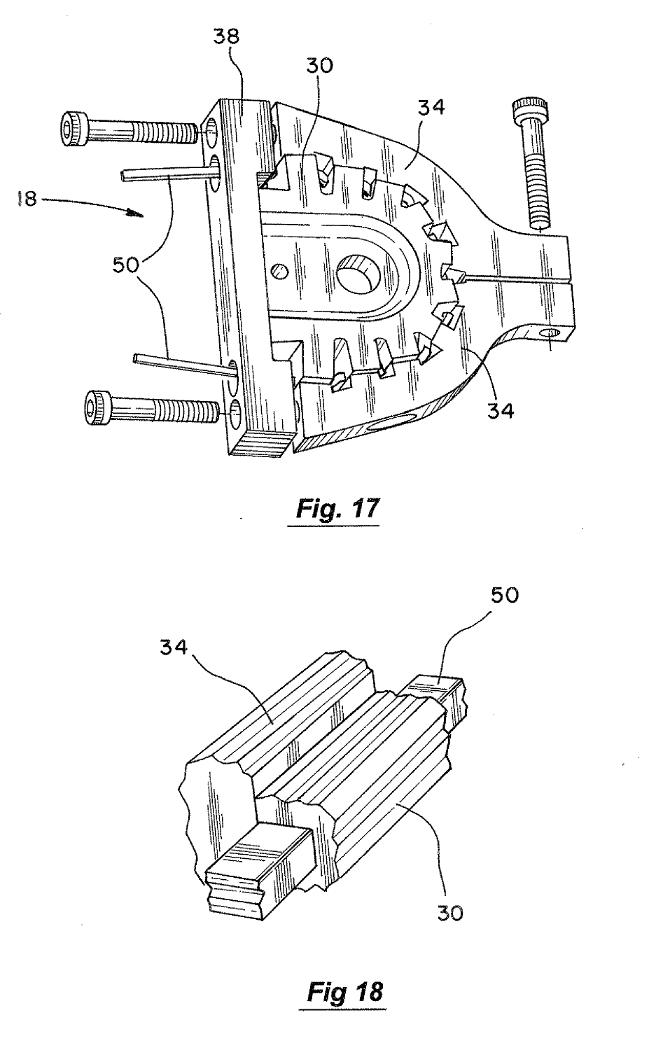

Once the wire 50 is laced into the arch slots 32, left and right wire holders 34 are brought into position relative to the mandrel 30. The left and right holders 34 represent second and third CNC machined parts whose configuration is derived from the same archwire datum orientations on which the webs 45 are based. These portions of the fixture 18 are also robotically machined along with the mandrel 30 in step 27 in FIG. 2. The left and right holders 34 are held very tightly in place by a threaded fastener joining the two halves and a fourth part. A distal brace 38 similarly serves to tighten the holders 34 into tight and intimate contact with the labial and buccal faces of the mandrel 30. The distal brace 38 further draws the holders 34 tight as two threaded fasteners are tightened. Once tightened, the mandrel 30 is considered to be loaded, as shown in FIG. 17. Alternative means for securing the archwire 50 into the slots 32 of the mandrel 30 include installation of bolt-down retainer plates 36 over all of the slots 32. One such retainer plate 36 is shown in FIG. 16. As shown in FIG. 17, clearance holes may be provided allowing the distal ends of the Ni—Ti wire 50 to extend out of the assembly. The mandrel 30 can be machined from a pre-formed blank (e.g., a cast aluminum blank) to reduce machining. The blank can also be equipped with registration features (e.g., mounting holes) to facilitate rapid registration and precise mounting of the blank within a CNC milling machine, as well as serving as a lumen for temporary ligatures to aid in loading the mandrel as described earlier.

Once the Ni—Ti wire 50 is secured within the mandrel 30 and retaining components (i.e., once the fixture is loaded), the entire assembly 18 is placed in a suitable furnace 19 and heated (e.g., to about 930° F.) for a period of time sufficient to allow the entire assembly to reach furnace temperature (step 29). Sheltering gases such as argon, hydrogen or nitrogen may be used or a vacuum may be used to prevent oxidation and discoloration of the surface of the archwire 50 being processed.

Furnace heating as described above may be replaced by other heating methods. For example, an electrical heating method employing sufficient voltage and sufficient amperage being conducted through the Ni—Ti wire segment to heat it to the target temperature is an alternative method. In the case of heating the Ni—Ti alloy wire electrically in this manner, the Ni—Ti heat-treating and shape-setting furnace mandrel can be CNC-machined from a non-conductive material. Suitable non-conductive materials would include materials such as ceramic, alumina, graphite or other machinable high-temperature materials.

The methods and devices of the present invention are useful for creating adaptive archwires of other biocompatible and resilient alloys besides Ni—Ti. Stainless steel wire segments, for example, may be processed through the devices and methods of the present invention. In such a case, the loaded mandrel must be heated to 850° to 900° F. for a minimum of 30 minutes. These steps will stress relive or normalize the stainless wire segment so that once cooled and removed from the fixture, it will retain is arch form and first, second and third-order activations. A normalizing step significantly reduces breakage of stainless steel components over the full term of orthodontic treatment. Installation of such a processed wire into the actual arch slots of the patient's brackets may necessitate bending and twisting, and the storage of energy as did the Ni—Ti wire example. Wire of other alloys may be suitable for heat setting or normalizing through the use of the present inventive devices and methods. Additionally, the present invention may be useful in forming polymer, resin-based or composite archwires and in particular such archwires that contain a reinforcing element. The present invention may serve to set such an archwire's configuration, allowing the reinforcing element to then resist deflection away from a shape and a configuration set by the present inventive device and methods.

In all cases, the resulting archwire is cooled, removed from the mandrel and installed in all of the arch slots of a patient's brackets for use in treatment. There are several methods for retaining archwires within the brackets including steel and elastomeric ligatures that serve to tie the archwire in place. Other brackets are of a special design where archwire-retaining features are integral to the bracket design. In the example described earlier involving a progressive series of such archwires, those are sequentially used in treatment according to the instructions and treatment plan established by the CAD technician and attending orthodontist.

It should be noted that other types of bends can be installed, especially applicable to round wires, where the overall morphologic shape can be set to match a patient's facial type, or bends directed toward opening closed bites or closing open bites, known as “Curve of Spee” bends. Other similar wires are know as “reverse curve of Spee” or RCS archwires. In addition, an embodiment could be envisioned that incorporates all the first, second, third order bends, width, arch shape, etc. and involves placing a wire between two coordinating halves of a fixture. The halves could then be secured together by a clip or screw. This embodiment might entail less CNC drilling and shaping for each archwire.

The mandrel 30 disclosed above is configured to first loosely accept an archwire 50 between the walls and floor of the arch slot 32 during loading. In other words, the archwire is first forced to at least partially enter the slot 32 where it is held in position by three surfaces of the slot 32 (i.e., the two walls and the floor). As a second step, a fourth side (a holder or a bolt-down retainer plate 36) is brought into registration with the slot 32 of the mandrel 30. When the holder or the plate is tightened, the archwire 50 becomes fully seated and is captured precisely within the fully enclosed slot 32. The relationship between the arch slot in the mandrel 30, the archwire 50 and the holder (or bolt-down plate) 34 is depicted in FIG. 18.

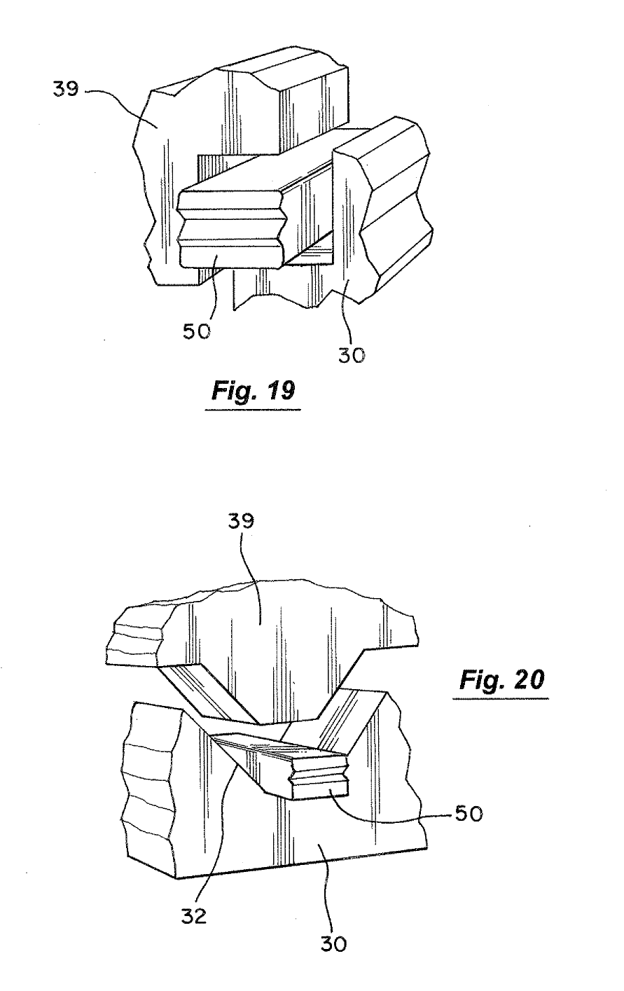

It should be understood that other configurations serving to restrict and direct the wire segment while holding it in its needed form are anticipated by the present invention. For example, precise capture of the archwire 50 can be accomplished where one portion of a mandrel 30 contacts and restrains the archwire 50 on only two of its four faces, and the other portion 39 of the fixture likewise contacts and restrains the remaining two faces, as shown in FIG. 19.

Still other configurations are anticipated with the objective being to reduce the time required to CNC-machine a mandrel 30 and its related fixture components and to reduce difficulty in loading the assembly. One such configuration is based on a combination in which one portion of the mandrel 30 contacts only one face of a square or rectangular archwire 50 and the other portion 39 of the fixture contacts an opposing face of the wire 50. Even though the wire 50 is captured on only two opposing faces, the funnel configuration adjacent to the wire-capturing features aid in positioning and orienting the archwire segment 50.

Another embodiment requires one half (the “female half”) of the mandrel 30 to have the opposite shape of a truncated wedge and the other half 39 (the “male half”) of the fixture would have a truncated wedge shape, as shown in FIG. 20. Assume, for clarity of concept purposes, that there are no first, second, or third order bends required and that just a custom shape and arch form are desired. The wire is placed in the female part, the male part is placed onto the female part. The two pieces are pressed together, then locked together by clamp, bolt, etc. The wire is forced into the female slot by the male truncated wedge (the clearance is equal to the thickness of the archwire). The wire is firmly held in place by the two halves and then placed in the furnace or other heating device. After heat treating and cooling, the two pieces are separated and the wire of the desired arch form and width is now ready to use.

Placing the first, second, third order bends involves CNC milling to reflect the desired changes in each half of the mold. The wedge-shaped receptacle in the female part would have sufficient depth to assure that the wire would be contained in the appropriate slot (i.e., pushed to the bottom of the female truncated wedge-shaped space. For third order bends, the truncated wedge receptacle in the female part and the truncated wedge in the male part would have the appropriate angle cut to reflect the desired torque angle for a particular tooth or set of teeth. The first, second, and third order bends can be cut so that there is contact with the wire continuously when the two pieces are placed together or there can be space cut between to reflect some or all of the intra-bracket space. This embodiment might allow fewer pieces and less hands-on work after the two pieces are made.

The preceding discussion has centered on conventional labial archwires. It should be expressly understood that the present invention could be readily adapted to set other types of orthodontic wires, such as lingual archwires. In addition, the fixture can be designed to hold the wire from either the lingual or labial sides. Alternatively, the fixture could be configured to hold the wire from above and/or below. For example, this could be accomplished by machining an arch-shaped groove with an appropriate depth profile into one portion of the fixture (e.g., the lower portion of the fixture), and forming the other portion of the fixture (e.g., the upper portion) to include complementary projections for holding the wire in the groove during heat treatment.

The scanning and virtual modeling capabilities discussed above can also be employed to scan and check the resulting heat-set wire to confirm that it has indeed emerged from the heat-treating process in the required biological configuration, with the intended first, second and third-order bends installed, and with the desired degree of over-activation, etc. For this, the actual resulting wire can be scanned, allowing the creation of a virtual version. The virtual wire can be superimposed onto the original virtual archwire that was swept between the arch slot datums. A comparison can confirm the accuracy of the actual archwire.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for setting an orthodontic archwire comprising:
creating a model for the desired shape of an orthodontic archwire in a computer-aided design (CAD) system by:
(a) creating a model of a patient's dental anatomy in the CAD system;
(b) manipulating the virtual teeth in the model of the patient's dental anatomy to a desired finished condition;
(c) installing virtual orthodontic brackets with arch slots on selected virtual teeth in the model of the patient's dental anatomy in the finished condition; and
(d) returning the virtual teeth with their virtual orthodontic brackets to their original positions in the model of the patient's dental anatomy;
creating a model of a fixture in the CAD system for setting a wire in a desired shape based on the arch slots in the virtual orthodontic brackets after the virtual teeth have been returned to their original positions in the model of the patient's dental anatomy, with activations so that the resulting archwire will store and transfer corrective energy to the patient's teeth;
employing a CNC milling machine to produce a fixture based on the model of the fixture in the CAD system;
assembling the fixture to hold a wire; and
heating the wire to a predetermined temperature for a period of time to set the wire.

2. The method of claim 1 wherein the step of creating a model of a fixture in the CAD system comprises creating a model of a fixture in the CAD system having slots to receive a wire based on the arch slots in the virtual orthodontic brackets.

3. The method of claim 1 wherein the fixture comprises:
a mandrel having a plurality of slots for receiving a wire; and
retaining parts removably attachable to the mandrel for retaining a wire in the slots of the mandrel.

4. The method of claim 3 wherein the mandrel is generally arch-shaped.

5. The method of claim 4 wherein the retaining parts form a complementary arch shape to the mandrel.

6. The method of claim 1 wherein the fixture further comprises registration features to facilitate registration of the fixture within the CNC milling machine.

7. The method of claim 1 wherein the wire is electrically heated to a predetermined temperature by passing an electrical current through the wire.

8. A method for setting an orthodontic archwire comprising:
creating a model for the desired shape of an orthodontic archwire in a computer-aided design (CAD) system by:
(a) creating a model of a patient's dental anatomy in the CAD system;
(b) manipulating the virtual teeth in the model of the patient's dental anatomy to a desired finished condition;
(c) installing virtual orthodontic brackets with arch slots on selected virtual teeth in the model of the patient's dental anatomy in the finished condition; and
(d) returning the virtual teeth with their virtual orthodontic brackets to their original positions in the model of the patient's dental anatomy;
creating a model of a fixture in the CAD system, wherein said fixture includes an arch-shaped mandrel with a plurality of slots for setting a wire in a desired shape based on the arch slots in the virtual orthodontic brackets after the virtual teeth have been returned to their original positions in the model of the patient's dental anatomy, with activations so that the resulting archwire will store and transfer corrective energy to the patient's teeth;
employing a CNC milling machine to produce a mandrel based on the model of the mandrel in the CAD system;
assembling the fixture by inserting a wire into the slots of the mandrel; and
heating the wire to a predetermined temperature for a period of time to set the wire.

9. The method of claim 8 wherein the step of creating a model of a fixture in the CAD system comprises designing slots in the fixture based on the positions of the arch slots in the virtual brackets after the virtual teeth have been returned to their original positions.

10. The method of claim 8 wherein the fixture further comprises retaining parts removably attachable to the mandrel for retaining a wire in the slots of the mandrel.

11. The method of claim 10 wherein the retaining parts form a complementary arch shape to the mandrel.

12. The method of claim 8 wherein the step of creating a fixture in the CAD system further comprises creating a model of retaining parts for removable attachment to the mandrel for retaining a wire in the slots of the mandrel, and further comprising the step of employing a CNC milling machine to produce the retaining parts based on the model of the retaining parts in the CAD system.

13. The method of claim 8 wherein the fixture further comprises registration features to facilitate registration of the fixture within the CNC milling machine.

14. The method of claim 8 wherein the wire is electrically heated to a predetermined temperature by passing an electrical current through the wire.

15. A method for setting an orthodontic archwire comprising:
creating a model for the desired shape of an orthodontic archwire in a computer-aided design (CAD) system by:
(a) creating a model of a patient's dental anatomy having virtual teeth with natural anatomical axes in the CAD system;
(b) manipulating the virtual teeth in the model to a desired finished condition in which the desired positions of the virtual teeth are defined by applying predetermined bracket prescription values to the orientations of the natural anatomical axes of the virtual teeth;
(c) installing virtual orthodontic brackets with arch slots and predetermined axes on selected virtual teeth in the model of the patient's dental anatomy in the finished condition, so that the axes of the virtual orthodontic brackets are substantially aligned with the natural anatomical axes of the virtual teeth; and
(d) returning the virtual teeth with their virtual orthodontic brackets to their original positions in the model of the patient's dental anatomy;
creating a model of a fixture in the CAD system for setting a wire in a desired shape based on the arch slots in the virtual orthodontic brackets after the virtual teeth have been returned to their original positions in the model of the patient's dental anatomy, with activations so that the resulting archwire will store and transfer corrective energy to the patient's teeth;
employing a CNC milling machine to produce a fixture based on the model of the fixture in the CAD system;
assembling the fixture to hold a wire; and
heating the wire to a predetermined temperature for a period of time to set the wire.

16. The method of claim 15 wherein the step of creating a model of a fixture in the CAD system comprises creating a model of a fixture in the CAD system having slots to receive a wire based on the arch slots in the virtual orthodontic brackets.

17. The method of claim 15 wherein the fixture comprises:
a mandrel having a plurality of slots for receiving a wire; and
retaining parts removably attachable to the mandrel for retaining a wire in the slots of the mandrel.

18. The method of claim 17 wherein the mandrel is generally arch-shaped.

19. The method of claim 18 wherein the retaining parts form a complementary arch shape to the mandrel.

20. The method of claim 15 wherein the wire is electrically heated to a predetermined temperature by passing an electrical current through the wire.
